(19) United States
(12) Patent Application Publication
(10) Pub. No.: US 2002/0123317 A1
(43) Pub. Date: Sep. 5, 2002

(54) Radio frequency module

(76) Inventors: Takuma Tanimoto, (US); Shinichiro Takatani, Koganei (JP); Hiroshi Kondoh, Fuchu (JP)

Correspondence Address: REED SMITH HAZEL & THOMAS LLP, 3110 Fairview Park Drive, Suite 1400, Falls Church, VA, 22042, US

(21) Appl. No.: 09/883,186

(22) Filed: Jun. 19, 2001

(30) Foreign Application Priority Data
Aug. 30, 2000 (JP) 2000-265991

(51) Int. Cl. H01P 1/00; H04B 7/00

(52) U.S. Cl. 455/252.1; 333/247; 333/32; 333/33

(57) ABSTRACT

A radio frequency module packaging system and method characterized by compact package size, reduced packaging loss and variation, and reduced heat generation. The radio frequency module is provided with via holes, electrodes for signals, and grounding electrodes on the surface of a substrate. Under the electrodes for signals, via holes are made, and on both sides of the electrodes for signals, grounding via holes are made so that these via holes form microstrip lines. Both input and output ends of a high frequency circuit including an active device, formed as the module's functional circuit on the substrate, are routed through the via holes and connected to another circuit.

### PRIORITY TO FOREIGN APPLICATIONS

This application claims priority to Japanese Patent Application No. P2000-265991.

### BACKGROUND OF THE INVENTION

1. Field of the Invention

The present invention relates to radio frequency modules and, more specifically, to radio frequency modules that are compact and provide enhanced performance through the use of an improved packaging method utilizing via holes for high-frequency amplifiers, oscillators and other devices.

2. Description of the Background

For radio frequency modules, a number of improvements in their packaging technique have been proposed due to the compactness desired for equipment using these modules. Packaging techniques that meet this compactness requirement, may utilize wiring using via holes instead of wire bonding. Even if via holes are used, as the frequency of signals to be processed by the above modules increases, the performance of the modules deteriorates by the impedance of the lines routed through the via holes, the result of which is not negligible.

As a means of reducing this effect of impedance, the following technique has been proposed. A radio frequency module is formed on a dielectric substrate with a signal-line via hole provided on the substrate, and capacitance is generated near the signal-line via hole to cancel the impedance of the line routed through the via hole. For example, as is shown in FIG. 10, signal patterns 27 are formed on both the front and rear surfaces of a dielectric substrate 26 and are connected with each other by a signal via hole 28 bored through the substrate 26. A conductor 29 is vertically installed near the via hole 28 to generate capacitance so that the characteristic impedance of the signal via hole 28 matches with the characteristic impedance of the signal patterns 27 (Japanese Patent Laid-Open Publication No. Hei 11-150371).

The previously known technique whereby the radio frequency module is made on the dielectric substrate as described above cannot be applied directly to a radio frequency module in which a high-frequency circuit is formed on a semiconductor substrate. Especially, the above-mentioned signal via hole is bored upright and it is difficult to increase its diameter. The resistance of the conductor through the hole is large, which causes a thermal loss problem. An optimum form of a grounding conductor is not disclosed. In addition to the compactness and improved characteristics that are required for making radio frequency modules, there may also be other problems such as heat generation of components.

### SUMMARY OF THE INVENTION

The present invention preferably realizes a radio frequency module on a semiconductor substrate by using via holes that have the features of compact package size, improved characteristics, and reduced heat generation.

According to at least one preferred embodiment of the present invention, a radio frequency module can be packaged on a semiconductor substrate with signal-line via holes and grounding via holes. These holes are made to form microstrip lines by semiconductor production process. The invention enables compact package size and reduced packaging loss and variation. The application of the thus produced radio frequency module preferably produces one or more of the following effects. If the module is used as an oscillator, the oscillation frequency of the oscillator is made stable and phase noise decreases. If the module is used as a high power amplifier, the amplifier with increased gain and efficiency is expected. Compact high frequency circuit and module with enhanced performance can be produced.

To attain the above object, the present invention packages a radio frequency module comprising a high frequency circuit having at least an active device and input/output signal lines thereof, formed on the front surface of a semiconductor, with the input/output signal lines being routed through signal-line via holes to the rear surface of said semiconductor, grounding via holes being provided near the signal-line via holes, and the signal-line via holes and the grounding via holes forming microstrip lines.

In the radio frequency module packaged on a semiconductor substrate, according to the present invention, the cross section of an example of the strip lines formed by the signal-line via holes and the grounding via holes is shown in FIG. 3A or 3B. If grounding conductors exist near the signal line on both sides of the signal line or a grounding conductor exists near the signal line on one side of the signal line, the capacitance between the signal line and the grounding conductor(s) can cancel the inductance of the signal line. This may make it possible to form a signal line of any impedance over a wide frequency range.

The impedance of the strip line is obtained as follows. Assume that the width and thickness of a signal-line via hole 13 are S and W, the width and thickness of a grounding via hole 12 are G and W. and the permeability and permittivity of the semiconductor substrate around the via holes 12 and 13 are μ₀ and ε₀ε respectively. If the sum of the width S of a signal-line via hole 13 and two times the distance L between the signal-line via hole 13 and its grounding via hole 12 is shorter than the width G of the grounding via hole 12, in the case of FIG. 3A, the impedance of the microstrip line is obtained by equation (1):

$$\begin{matrix}[ Equation 1 ] & \\ Z = \frac{1}{4} \sqrt{\frac{{μ}_{0}}{{ϵ}_{0} {ϵ}_{τ}}} \frac{2 L + w}{S} & ( 1 )\end{matrix}$$

In the case of (b) the impedance of the microstrip line is obtained by equation (2):

$$\begin{matrix}[ Equation 2 ] & \\ Z = \frac{1}{2 π} \sqrt{\frac{{μ}_{0}}{{ϵ}_{0} {ϵ}_{τ}}} log \{ {F}_{1} \frac{L}{S} + \sqrt{1 + {( \frac{2 L}{2} )}^{2}} \} & ( 2 )\end{matrix}$$

where, F1 is a material parameter.

If the semiconductor substrate is made of, for example, GaAs, and W=10 μm and S=100 μm in order to attain a desirable value of 50 ohms as the impedance of the microstrip line, L becomes 50 to 100 μm for the example line in FIG. 3A or 3B. Forming the via holes with such a short distance L therebetween can be achieved by a dry etching technique; a groove which is 10 to 20 μm wide is etched up to approximately 100 μm by dry etching.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a diagram showing an example of equipment comprising high frequency circuitry in which radio frequency modules of the present invention are used;

FIGS. 2A to 2D illustrate a radio frequency module according to the present invention;

FIGS. 3A and 3B illustrate a strip line that is formed by the present invention;

FIG. 4 is a perspective view of a radio frequency module according to the present invention;

FIG. 5 is a perspective view of a radio frequency module according to the present invention;

FIG. 6 is graphical representation illustrating the effect of a radio frequency module made according to the present invention;

FIG. 7 is graphical representation illustrating the effect of a radio frequency module made according to the present invention;

FIG. 8 is a plan view of a radio frequency module according to the present invention;

FIG. 9 is graphical representation of the result of measurement of the thermal radiation effect of the embodiment shown in FIG. 8; and

FIG. 10 is a plan view of a conventional radio frequency module.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings.

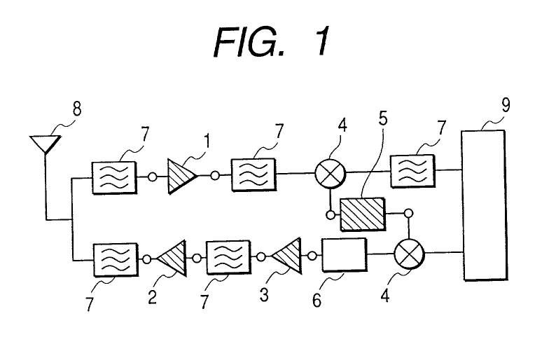

FIG. 1 shows an example of equipment (in this case a transceiver) comprising high frequency circuitry in which radio frequency modules of the present invention may be used. This high frequency circuitry may be similar to previously known high frequency circuitry. Signals received by an antenna 8 pass through a filter 7, a low noise amplifier for receiver 1, a filter 7, a mixer 4, and a filter 7 (in order) and input to a baseband circuit 9 where they are processed for reception. Baseband signals to be transmitted pass through a mixer 4, a burst switch 6, a variable gain amplifier 3, a filter 7, a high power amplifier for transmitter 2, and a filter 7 in order and transmitted from the antenna 8. Signals from an oscillator 5 are added to the mixer 4.

In this circuit diagram, radio frequency modules of the present invention may be used for at least some of the shaded elements of this circuitry, which include active devices such as the low noise amplifier for receiver 1, the high power amplifier for transmitter 2, the variable gain amplifier 3, and the oscillator 5. The small circles in FIG. 1 represent the sections of via holes where the above-mentioned microstrip lines may be formed.

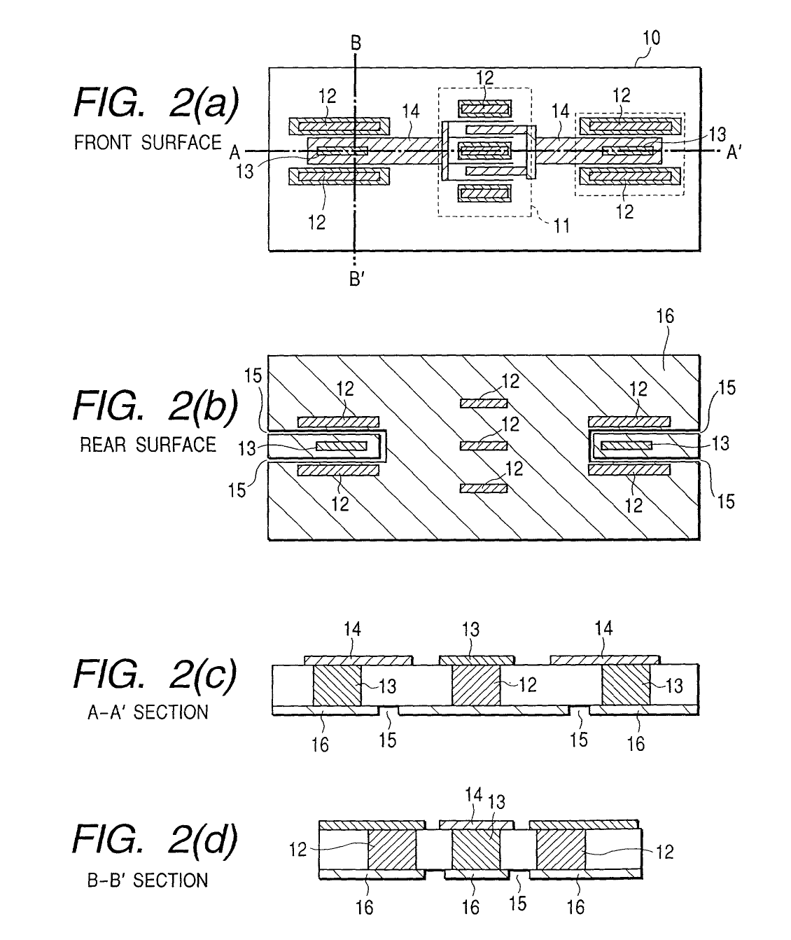

FIGS. 2A to 2D illustrate a radio frequency module configured as a presently preferred embodiment of the invention. This preferred embodiment includes a radio frequency module with an active device of multi-finger electrode structure as an example. FIGS. 2A to 2D show the front surface, rear surface, A-A′ section, and B-B′ section of the module, respectively.

The radio frequency module is configured as follows. On the front surface of a semiconductor substrate 10, an amplifier circuit 11 with the active device of multi-finger electrode structure and its input/output signal lines are formed. The input/output signal lines 14 are routed through signal-line via holes 13 to the rear surface of the semiconductor substrate. Grounding via holes 12 are made on both sides of the via holes 13. The signal-line via holes 13 and grounding via holes 12 form the microstrip lines with the semiconductor substrate 10.

Grounding electrodes of the multi-finger electrodes are connected to the rear surface of the semiconductor substrate 10 through the grounding via holes 12. The rear surface of the semiconductor substrate 10 is preferably covered with metal 16 except at boundary zones 15 between the signal-line areas and the grounding areas. On the metal surface, barrier metal and solder layers are formed for diffusion prevention.

The production of the above module embodiment of the invention will now be explained. After the amplifier 11 is formed on the surface of the semiconductor substrate 10 by usual semiconductor production process, the holes 13 for signal lines 14 and the holes 12 for grounding are made in desired position on the semiconductor substrate 10 by photolithography. As detailed in the cross section of these holes, the dimensions are preferably set as follows: for example, the thickness is 10 μm and the distance between holes is 50 μm.

Thereafter, the semiconductor substrate 10, with the holes 13 and 12, is etched approximately 70 μm by a dry etching process. After removing the photoresist from the surface of the substrate, metal evaporation on the inner walls of the holes 13 and 23 is performed by the sputter-deposition method. After holes are made in the desired position by photolithography, the surface of the substrate is covered with metal by selective electroplating.

With the front surface of the semiconductor substrate 10 being stuck to another substrate, the other (rear) surface is processed by mechanical grounding and wet etching to reduce the thickness of the substrate approximately 10 to 80 μm. On the rear surface of the substrate, holes are made in position by photolithography and etched by wet etching so that the holes 13 made on the front surface will be open therethrough. Thereafter, the rear surface of the substrate is preferably covered with metal 16 and a pattern 16 is formed on the rear surface including the grounding via holes 12, as shown in FIG. 2B, by photolithography and milling.

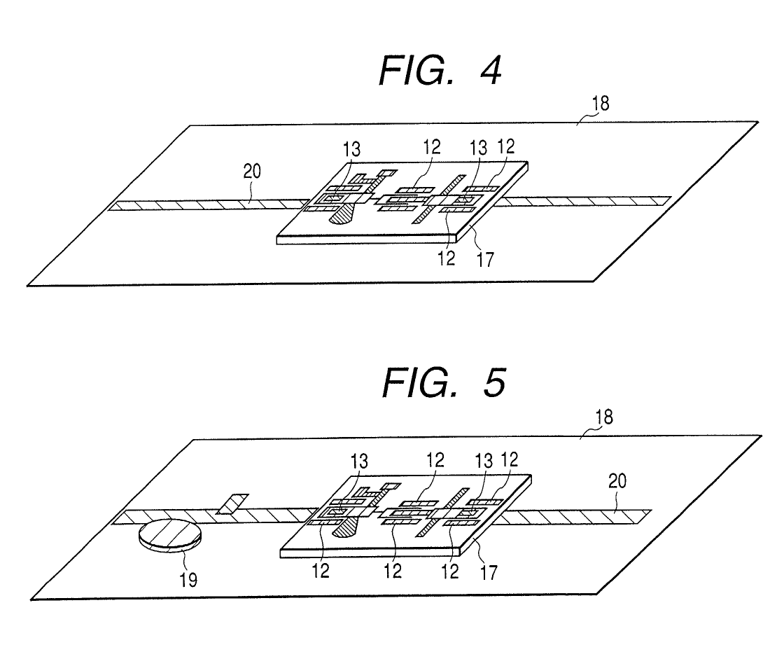

FIG. 4 and FIG. 5 are perspective views of radio frequency modules according to several preferred embodiments of the present invention. In FIG. 4, the radio frequency module 17 including an oscillator is mounted on the mounting substrate 18, which is an isolated substrate on which a line conductor 20 is formed, so that the signal-line via holes on the rear surface of the radio frequency module 17 are aligned on the line conductor 20.

The oscillator performance of the radio frequency module was measured. Upon testing, it is shown that the performance of the oscillator in the above embodiment before being mounted has an oscillation frequency of 76.5 GHz, frequency dispersion of 0.1 GHz, and output of 6.0 dBm. The performance of the oscillator radio frequency module, after being mounted as shown in FIG. 4, included an oscillation frequency of 76.5 GHz, frequency dispersion of 0.1 GHz, and output of 5.9 dBm. When the same module was mounted by using wire bonding instead of via holes, its measured performance included an oscillation frequency of 74 GHz, frequency dispersion of 1.3 GHz, and output of 3.2 dBm. When the same module was mounted by using signal-line via holes, but without using grounding via holes, its measured performance included an oscillation frequency of 76.3 GHz, frequency dispersion of 0.2 GHz, and output of 5.8 dBm.

In the embodiment shown in FIG. 5, the radio frequency module, which is preferably produced by the same process as that used for producing the radio frequency module shown in FIG. 4, but the oscillation circuit was removed from the module, is mounted on the dielectric substrate 18 including an external dielectric resonator 19. The process for mounting the module on the substrate was the same as in this embodiment; the rear surface of the substrate 17 was covered with AuSn for solder connection, and its barrier material Ni (for diffusion prevention) and the dielectric substrate 18 was heated.

The performance of the oscillator embodied as shown in FIG. 5 was also measured. The measured results included an oscillation frequency of 76.5 GHz, frequency dispersion of 0.1 GHz, and output of 8.5 dBm. As is the case with the first oscillator embodiment, oscillator examples of conventional RF module type 1 and 2 were also created for comparison with the oscillator embodied. For the oscillator example 1 of conventional RF module type, no oscillation was observed. For the oscillator example 2 of conventional RF module type, its performance measurements were oscillation frequency of 76.2 GHz, frequency dispersion of 0.4 GHz, and output of 8.0 dBm.

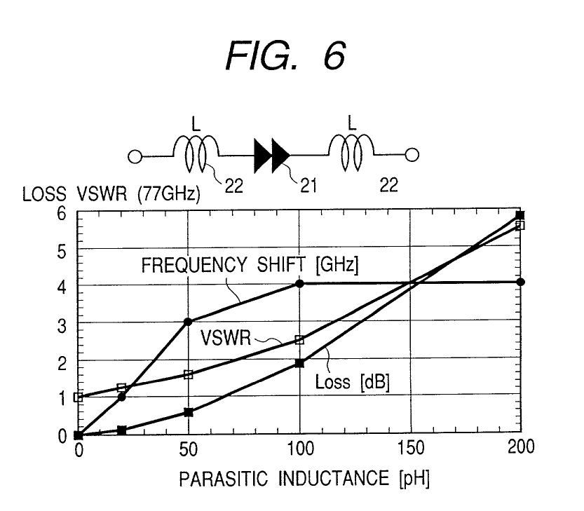

FIG. 6 shows the result of simulation of the radio frequency module as the high power amplifier made, according to the present invention. In a case where inductance 22 is inserted before and after the high power amplifier circuit 21 with the peak gain at 77 GHz, the frequency peak shift, voltage standing wave ratio (VSWR), and loss were measured during the simulation. For the comparable amplifier RF module for which wire bonding is used, parasitic inductance of about 200 pH usually occurs. Thus, the frequency shift of 4 GHz and loss of about 6 dB, which are too large for normal applications, were observed. For the comparable amplifier RF module for which only conventional signal-line via holes are used, inductance of about 20 pH occurs, causing loss of about 0.2 dB. In contrast, the amplifier RF module embodiment of the invention has little loss because parasitic inductance is substantially eliminated.

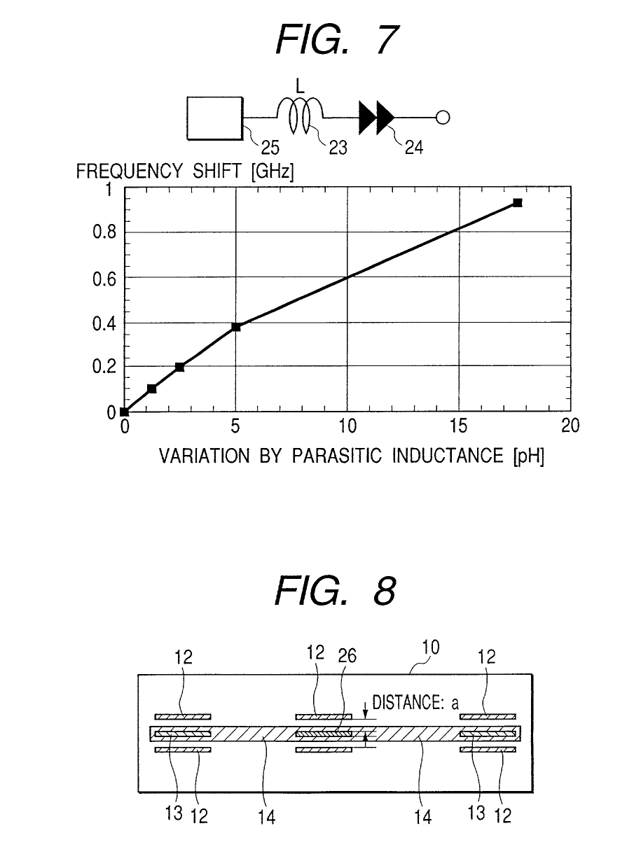

FIG. 7 shows the result of simulation of the radio frequency module as the oscillator made, according to the present invention. Simulation was carried out for a circuit 25 that oscillates at 76.5 GHz in conjunction with an amplifier circuit 24 and inductance 23. For the comparative oscillator RF module for which wire bonding is used, no oscillation was observed. For the comparative oscillator RF module for which only conventional signal-line via holes are used, if the inductance is assumed to vary about 5 pH of the actual measurement, the frequency dispersion of oscillation of 0.4 GHz was observed. This value of dispersion is very close to 0.5 GHz that is the permissible dispersion of frequency for the oscillator circuit, which means that the yield of such oscillator would be little. In contrast, for the oscillator RF module embodiment of the invention, there is no need of considering such dispersion, and therefore stable device performance can be provided.

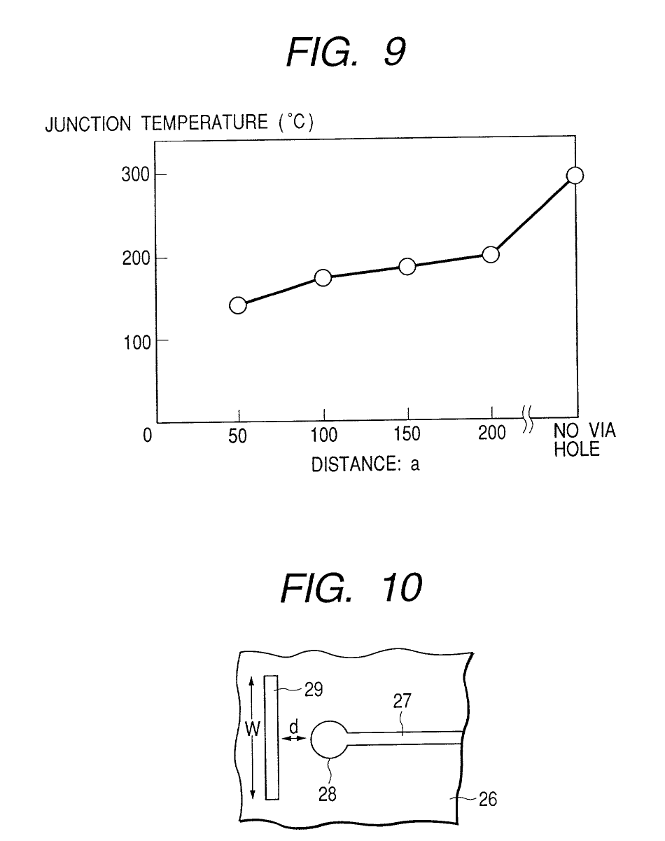

FIG. 8 shows a radio frequency module configured as another embodiment of the present invention, and FIG. 9 details graphical results of measurements of the thermal radiation effect thereof.

In FIG. 8, on a GaAs substrate 10, a heater 26 including an active device and its input/output lines 14 are formed and signal-line via holes 13 and grounding via holes 12 are made at the ends of the input/output lines. Furthermore, on both sides of the heater 26, grounding via holes 12 are made at a distance “a” from the heater corresponding to the distance of the grounding via holes 12 from the signal-line via holes 13.

FIG. 9 shows how the temperature (junction temperature) near the heater 26 grades as the distance “a” increases in the above embodiment. As evident from the graph in FIG. 9, a significant heat radiation effect is observed in the range of the above distance from 50 to 200 μm.

The amplifier and oscillator RF module embodiments of the present invention were discussed above. However, the present invention is not limited to these particular embodiments and may be applied to high frequency analog circuits such as mixers; digital circuits such as multiplexers and demultiplexers; optical devices; and other electronic circuits. Particularly, the present invention may be applied to electronic equipment including high frequency active devices such as radar sensors and transceivers.

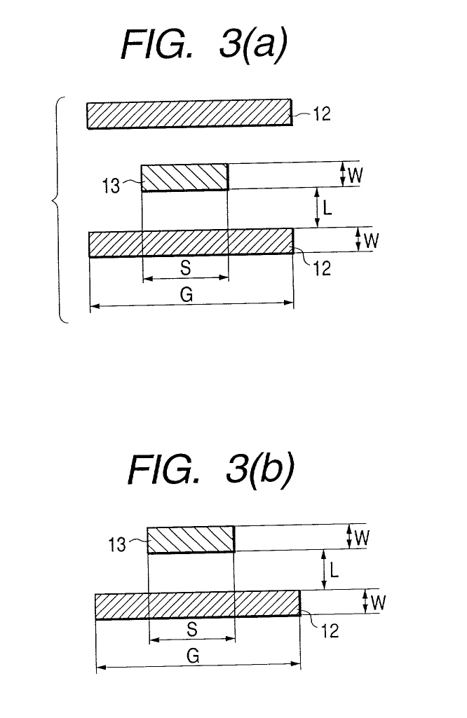

The substrate thickness and the gap and width of the via holes used in the embodiments of the invention were presented by way of example only and can be altered within the scope of the present invention. Although the case where the grounding via holes are made on both sides of one signal-line via hole was discussed in the embodiments, it is also possible to arrange a microstrip line type in which a grounding via hole is made only either side of one signal-line via hole as shown in FIG. 3B.

What is claimed is:

1. A radio frequency module, comprising:
a semiconductor having a front surface and a rear surface; and
a high frequency circuit having at least one active device and input/output signal lines formed on the front surface of the semiconductor, said input/output signal lines being routed through at least one signal-line via hole to the rear surface of said semiconductor, wherein at least a first grounding via hole is formed near said at least one signal-line via hole, wherein said at least one signal-line via hole and said first grounding via hole form microstrip lines.

2. The radio frequency module according to claim 1, wherein at least a second grounding via hole is provided near said active device.

3. The radio frequency module according to claim 1, wherein said active device is a multi-finger electrode structure and further wherein grounding electrodes of said multi-finger electrodes are connected to the rear surface of said substrate through at least the second grounding via hole.

4. The radio frequency module according to claim 2, wherein said active device is a multi-finger electrode structure and further wherein grounding electrodes of said multi-finger electrodes are connected to the rear surface of said substrate through at least the second grounding via hole.

5. The radio frequency module according to claim 1, wherein the sum of the length of any one of said at least one signal-line via hole and twice the distance between said at least one signal-line via hole and the first grounding via hole is shorter than the length of said first grounding via hole.

6. The radio frequency module according to claim 4, wherein the sum of the length of any one of said at least one signal-line via hole and twice the distance between said at least one signal-line via hole and the first grounding via hole is shorter than the length of said first grounding via hole.

7. The radio frequency module according to claim 1, wherein the impedance of the microstrip lines is set to a value that is approximately the same as the characteristic impedance of said input/output signal lines.

8. The radio frequency module according to claim 6, wherein the impedance of the microstrip lines is set to a value that is approximately the same as the characteristic impedance of said input/output signal lines.

9. The radio frequency module according to claim 1, wherein both said at least one signal-line via hole and the first grounding via hole are rectangular micro via holes with a width of 20 μm or less.

10. The radio frequency module according to claim 3, wherein both said at least one signal-line via hole and the first grounding via hole are rectangular micro via holes with a width of 20 μm or less.

11. The radio frequency module according to claim 8, wherein both said at least one signal-line via hole and the first grounding via hole are rectangular micro via holes with a width of 20 μm or less.

12. The radio frequency module according to claim 1, wherein the rear surface of the substrate includes signal-line areas through which the signal line via holes extend and grounding areas through which the first and second grounding via holes extend, further wherein said rear surface is covered with metal except in boundary zones between the signal-line areas and the grounding areas.

13. The radio frequency module according to claim 3, wherein the rear surface of the substrate includes signal-line areas through which the signal line via holes extend and grounding areas through which the first and second grounding via holes extend, further wherein said rear surface is covered with metal except in boundary zones between the signal-line areas and the grounding areas.

14. The radio frequency module according to claim 8, wherein the rear surface of the substrate includes signal-line areas through which the signal line via holes extend and grounding areas through which the first and second grounding via holes extend, further wherein said rear surface is covered with metal except in boundary zones between the signal-line areas and the grounding areas.

15. The radio frequency module according to claim 11, wherein the rear surface of the substrate includes signal-line areas through which the signal line via holes extend and grounding areas through which the first and second grounding via holes extend, further wherein said rear surface is covered with metal except in boundary zones between the signal-line areas and the grounding areas.

16. The radio frequency module according to claim 1, wherein the rear surface of said semiconductor substrate is covered with solder metal which is further covered with a barrier metal lamination for diffusion prevention.

17. The radio frequency module according to claim 13, wherein the rear surface of said semiconductor substrate is covered with solder metal which is further covered with a barrier metal lamination for diffusion prevention.

18. The radio frequency module according to claim 14, wherein the rear surface of said semiconductor substrate is covered with solder metal which is further covered with a barrier metal lamination for diffusion prevention.

19. A transceiver, comprising:
a semiconductor having a front surface and a rear surface; and
a transceiver circuit including input/output signal lines formed on the front surface of the semiconductor, said input/output signal lines being routed through at least one signal-line via hole to the rear surface of said semiconductor, wherein at least one grounding via hole is formed near said signal-line via holes, wherein said signal-line via holes and said grounding via holes form microstrip lines.

20. A sensor, comprising:
a semiconductor having a front surface and a rear surface; and
a high frequency sensor circuit including input/output signal lines formed on the front surface of the semiconductor, said input/output signal lines being routed through at least one signal-line via hole to the rear surface of said semiconductor, wherein at least one grounding via hole is formed near said signal-line via holes, wherein said signal-line via holes and said grounding via holes form microstrip lines.
